(19) United States
(12) Patent Application Publication
(10) Pub. No.: US 2012/0239836 A1
(43) Pub. Date: Sep. 20, 2012

(54) Snap Hook Enclosure Housing Case

(76) Inventor: Babak Enayati, Los Angeles, CA (US)

(21) Appl. No.: 13/368,328

(22) Filed: Feb. 7, 2012

Related U.S. Application Data
(60) Provisional application No. 61/465,431, filed on Mar. 18, 2011.

(51) Int. Cl. G06F 13/14; G06F 1/16

(52) U.S. Cl. 710/74; 361/679.31

(57) ABSTRACT

A protective housing case for a portable data storage device such as a USB flash drive, which includes an enclosure housing body that comprises of an adjoining snap hook, a sliding rod assembly, hook connector assembly, a resilient object, and an end stopper. The sliding rod assembly travels through a guiding slot, which in turn unveils a hook opening area, whereupon external attaching objects can be disconnected, enabling insertion of the device to a corresponding peripheral via the interface connector.

### CROSS-REFERENCE TO RELATED APPLICATIONS

This application claims the benefit of provisional patent application Snap Hook Enclosure Housing Case, Ser. No. 61/465,431, filed Mar. 18, 2011 by the present inventor, which is incorporated by reference.

### BACKGROUND OF THE INVENTION

It is truly a marvel how technology has evolved so rapidly at such an ever advancing rate in the past several decades. The internet, the single greatest contraption ever to revolutionize the world, has made global communications and the massive availability of information instantly available at one's fingertip, at the stroke of a key and the click of a mouse, one character at a time.

Television sets, which at times required several persons to physically carry, are now light enough for a single person to carry, and thinner than a school textbook. Mobile phones, which were previously limited to large bulky contraptions and car phones, are now smaller than a wallet, and can be taken virtually anywhere on the planet, and affordable enough for the average person to own. Originally limited to communicating via basic audio calls, they have evolved from such crude devices into multi-functioning communication super-hubs, conveniently incorporating cameras, calculators, televisions, alarm clocks, videophones, and music players, among other functions, all in one device.

Computers, which were originally manifested as massive room occupying contraptions comprising of vacuum tubes, have evolved from the afore to incredibly slow and limited machines with basic microprocessors to lightning fast devices which become faster, more capable, and advanced every day. So much so, that new computers create an actual phenomenon, an enigmatic predicament that renders the previously made model obsolete shortly after it rolls off of the assembly lines. It is undeniable that much of the technology that we have today at our disposal was simply seen as unfathomable and inconceivable only a few short decades ago. Moore's law is clearly fast track in motion, and the world is now meticulously interconnected, and well in its way in the digital age, the era which strikingly defines the 21st Century. In the ever evolving world, design must therefore accordingly be perfected to properly adapt technology at such an ever advancing rate.

From the original floppy disks, to zip drives, to compact disks and digital video disks, to external hard drives, the newest innovation in portable data storage is the removable data drive. One of the most commonly used drives is the USB flash drive, also known as a thumb-drive or disk-on-key. Based on internal flash memory, as well as the Universal Serial Bus specification standard, USB flash drives are in turn rewritable, and can hold up to hundreds of gigabytes of data. Unlike conventional hard disks, there are no motors or movable mechanical components, which make data reading and writing faster, quieter, and more reliable. In contrast, removable data devices such as USB flash drives are solid state devices, which utilize chips to store and access data. The innovation has continued with advances in speed and efficiency being increased, capabilities and features being added, and an ever decreasing physical size.

Archives of documents, photographs, and audio that would traditionally take up vast amounts of physical space can now all be digitally fitted into such a device, which conveniently fits onto the palm of one's hand. USB flash drives thus offer an excellent balance in the potential size storage versus physical size ratio, as a portable mass storage device. Consequently, it is therefore imperative to be able to safely manage such a small device which has such monumental storage capabilities.

The fact that USB flash drives are now affordable and are subsequently a common everyday part of routine carry-around items like wallets, keys, and cell phones make them very vulnerable and prone to normal wear and tear which occurs throughout the duration of conventional transportation and use. Subsequent problems can and will arise, such as the device incurring physical damage and breaking apart and malfunctioning.

Overall damage to the device is therefore non-avoidable, and worse, there is one key component which falls victim to such damage, which can cause detrimental problems. Portable data storage devices such as USB flash drives typically have a groove or U-shaped opening molded to the enclosure body, whereupon a connecting ring such as a keyring may be inserted. This ring in turn, attaches to a corresponding attachment peripheral, such as a user's keychain, lanyard, necklace, or keyfob, and can subsequently be disconnected whenever the USB flash drive is desired to be inserted into a matching USB port, for instance on a computer. The problem is that these linkage areas fall apart, and once they do, there is no way to attach the drive to such a peripheral. Moreover, these areas are often the first to break, being that they are smaller and thinner, and this vulnerability jeopardizes the safety of the device, being that it leads to the device being by itself, and not being able to attach to any other items. Due to the small size, the device can now easily be lost and misplaced, a huge problem which can lead to theft, tampering of data, loss of data, and will of course call for replacement of a new device.

This scenario occurs too often, irrespective of how often the USB flash drive is used, the particular model from a given manufacture, or how much care is taken to avoid damage to the drive. These linkage areas that attach to connecting rings such as keyrings ultimately break apart, and once this occurs, a user is subsequently left with having to hold on to the lone drive, which now absent of the added protection of being able to fasten to a keyring, greatly increases the likelihood of loss, theft, and misplacement. Therefore, because such linkage areas are weak and are accordingly more frequented to break over normal use, such a method is no longer viable as a safe, reliable means of attachment and detachment, particularly in the long term life of the device.

It is important to note that even if the linkage area was not easily susceptible to damage, the entire framework and structure of such a function is limited and problem prone to begin with, and the trouble with the approach is twofold. First, taking off the USB flash drive from the keyring is a hassle, and is time consuming. Typical items that are attached to a keyring are meant to stay on, and in cases where they are taken off, it is not for a normal, routine occurrence. For instance, to take off one's car key which is always stationary on a keyring, fastened as part of a set of keys, so that a friend can borrow a car, a seldom occurring event. The nature of USB flash drives call for constant and often use, which means that a method needs to be implemented whereupon a drive can easily be attached, detached, and reattached, that is quick, efficient, reliable, and simple. Secondly, in the event that a user does not wish to take off the drive from the keyring, the user must leave all the attached keys, key fobs, and other accessories which are part of their keyring system dangling on to the drive when it is inserted into a device such a computer. This is a nuisance, due to all the extra weight of the accessories, and it additionally amounts to a larger security risk, since now the drive, in addition to all the keys and accessories, can be left behind, and become lost and misplaced. It is therefore evident that a faster, safer, and more efficient approach must be implemented to replace the existing attachment method.

### PRIOR ART

Portable data devices of mass storage grade are now a commonplace item in the technologically advanced world in which we all live in. Such devices, notably USB flash drives, can now contain volumes of information, at times realistically holding an entire hard drive's worth of data on a single solid device. Big things really do come in small packages, and coupled with the fact that this data powerhouse is so portable, the end result is a very formidable device which has the ability to contain a massive amount of information in such a very small, compact contraption. Ultimately, this translates to a powerful tool that offers extreme convenience albeit at a cost.

While the device is handy and useful in storing, transporting, and accessing data, there are accompanying implications which must accordingly be dealt with. The potential for disastrous consequences to arise exists, and will persist, if proper care is not given to such a device, whereby theft and loss will subsequently occur. Although loss of data is a serious concern in itself, what happens to that data after it is lost is an even larger concern, and repercussions can include unauthorized access of such data, leading to further serious security issues. The consequences can be especially severe if highly personal, sensitive, and confidential files are on such a drive.

Even with due diligence and care, accidents do inevitably occur, and users may still haphazardly forget, lose, or misplace a USB flash drive due to their own negligence. Isolating these instances aside, the main cause of concern that needs to be addressed is the physical embodiment of the device itself. This cause of concern is twofold, and the first issue is that USB drives are subject to accelerated wear and tear, being that they are subjugated as part of everyday carry-around items, such as wallets, keys, and cell phones. Due to this fact, the outside portions of a drive, namely the areas of the housing, are the portions which are most prone to sustain physical damage from external factors. Although improvements can be made to limit damage from external factors with regards to the housing, damage still inevitably occurs.

Since proper care must be given, portable data storage devices such as USB flash drives are most vulnerable to being misplaced when they are left alone. This leads to the secondary issue, concerning the linkage areas in which such drives are used to connect to external attaching peripherals, such as keyrings. USB Flash drive devices are commonly made with grooves, notches, and areas which a connecting ring may be accordingly fastened. Since these areas provide the linking contact point, they are a crucial portion of the assembly, and the safety of the device can be jeopardized if damage accrues.

Thus, the potential for loss and misplacement is subsequently higher, due to the routine expected wear and tear which the devices are already accustomed to being inflicted. Moreover, what is worse is that due to the nature of these linkage areas, they are oftentimes very thin, flimsy, and not well supported, and in addition to the routine damage that the entire device incurs, are even more vulnerable to damage, based on the merits of the design. That being said, once damage occurs and the areas are broken, the device is no longer able to be attached to an external item. Devoid of this function, the drive is now separate from the attaching peripheral, be it a set of keys on a keychain, a zipper, a belt loop, or a lanyard, resulting in a higher likelihood of potential loss and misplacement, as well as serving as an added inconvenience and overall nuisance, being that the device is now alone by itself. Thus, there is a need for a stable apparatus which is durable enough to function as a means of linkage, in connecting to external attachments.

An additional need is offering an easy means of use that is both fast and efficient, for fastening and unfastening such a storage device to such attachments. Conventional means call for unfastening the device from an external attachment, and the intermediary means to do so often being a keyring, and in such a case, the keyring must be unfastened in order for the drive to be inserted onto a device such as a laptop. The alternative of course, is to leave the corresponding attachments engaged to the device, for instance an entire set of keys fastened to a keyring remaining attached, and accompanying the device when inserted into a corresponding mating port, such as a USB port of a computer. In the busy, high demand world which exists, engaging in such an action is extremely cumbersome, time consuming, and inefficient. Therefore, there is a need to enable such a means of attachment that can be fastened and unfastened relatively quickly in a short amount of time, with low hassle and convenience.

None of the following cited works are believed to detract from the patentability of the claimed embodiments of the invention. Currently, there are USB flash drives which incorporate carabiners on the housing body, utilizing a clip that when pushed, opens an enclosure area so that items such as keyrings may be taken out.

The problem with such carabiner clip devices is that they are not durable, and they succumb to the same problem that the area which attach to keyrings fall victim to, in that they break apart. The clips are oftentimes thin and flimsy, and simply do not last long, and easily break apart over use. The problem is detrimental, as the entire safety of the device is centered on such a clip, which has the extreme potential to break apart due to the nature of the design.

Such devices suffer from poor design and workmanship, and I have found that the carabiner clips easily snap and break over use. While USB devices are prone to normal wear and tear over continued use, these devices in question break apart easily just by the nature of the design, irrespective of the duration or frequency of use. In short, the vulnerability has nothing to do with wear and tear, but rather, is an inherent design flaw which comes standard in such devices. That being said, such carabiner style USB devices are essentially no different than the originally mentioned traditional USB flash drive devices, regarding the initially mentioned issue concerning the vulnerabilities of the linkage area for attaching connecting rings. Both contain small, dedicated core components which are responsible for attachment, and both are prone to breakage over time. Thus, such carabiner devices do not achieve any substantial advancement with regards to a device that offers a more secure means of attachment that is more durable than the conventional USB flash drive devices, and ultimately achieve negligible results in offering a secure means of attachment.

In addition to such compact models, certain carabiner USB devices are often made large and bulky, and subsequently take up a lot of physical space. Such a device can especially be cumbersome when clipped on to a key ring that is in turn fastened to a user's keychain, which has numerous keys, keyfobs, and other accessories fastened to it. The extreme size of the device consequently makes fastening it to a user's keychain a nuisance, which is not only awkward and uncomfortable, but may not even fit in certain sized pockets.

Regardless of size, the carabiner devices are very susceptible to being inadvertently detached, due to the fact that a substantial amount of pressure is not necessary to open the carabiner clip. That being said, such clip methods are not a very secure method of attachment, since simple pressure such as holding the clip against an edge or bulge at the necessary angle can open the clip, which can result in detachment, unbeknownst to the user. I have found this to occur frequently with various different carabiner models, and have frequently had the drive detached from my keys after being attached.

Thus, a carabiner style device does not meet the standards of what a reliable portable storage housing device such as a USB flash drive falls into, with regards to physical appearance, features, and functionality. Ultimately, these shortcomings and limitations substantially limit the device to be used as a convenient, reliable, and durable device which can be implemented for everyday use.

### ADVANTAGES

As far as attachment and detachment of the device from an external component is concerned, the embodiments of this invention are substantially superior to traditional USB flash drive devices. The fact that the device can be detached from an external object such as a keyring, lanyard, belt loop, or other object is an improvement, but the fact that this can be done is mere seconds, all the while being done so in a safe, efficient, and reliable manner is a substantial breakthrough.

The nature of the device is much safer and more reliable than conventional carabiner style designs, which are currently used as an alternative to traditional USB flash drive devices. Carabiner style devices fall short with their own downfalls, namely that they have fragile clips which are often thin and flimsy, do not require an ample amount of pressure to open, and can inadvertently be opened without a user's knowledge.

The embodiments of this invention offer a much safer and efficient alternative, and do so by utilizing a resilient object such as a spring, whereby a relatively larger amount of force is required to engage the device. In addition, if such a case of an inadvertent opening were to arise, it would be more difficult to occur, being that the release of the resilient object, such as a spring, could only occur via the release tab, which is the sole way of opening the spring. The release tab is a relatively smaller component which requires to be gripped properly, and requires a relatively larger amount of force to engage proper compression of the resilient object. Thus, while carabiner style USB flash drive devices may inadvertently open simply by coming into contact with other objects, in this case, the chances of external objects inadvertently causing the device to open are substantially lower. Therefore, due to the robust, more sophisticated design, there is subsequently a more secure means available to reduce the chances of the device being inadvertently opened, due to the nature of the embodiments of the invention.

Moreover, such carabiner style devices offer further limitations and drawbacks. Oftentimes, they are extremely large and bulky, and do not represent the traditional scope of what is optimally functional per portable data storage device standards. Such devices are cumbersome, awkward, and get in the way of users who prefer and appreciate such USB flash drive devices for the fact that they are small, light, and indiscreet. On the flipside, there are also carabiner style devices that are offered in more conventional style sizes and shapes, and are much more compact. The problem with these is that because the overall size of the device is smaller, proportionally, the carabiner clips are additionally shrunk to maintain proper proportion to the device. As a result, they suffer from a fatal flaw, namely that they are not durable and do not last relatively long, and in contrast have clips that are small, thin, and flimsy, which can easily become damaged and break.

The embodiments of this invention are not bound by any size constraints and can subsequently be made in any type of size, large or small, and still maintain the same proper functionality all the while not being cumbersome, excessively large or bulky, or awkward in appearance and handling. The embodiments additionally do not require being of a predetermined size in order to function better and offers substantially improved workability or durability. In contrast to other devices, the embodiments of the device still contour to the rigors and standards of typical portable data storage devices, namely in regards to being relatively reasonable in both size and physical appearance.

The embodiments of the invention are also superior concerning their design and basic structure. In the embodiments, the internal data storage device and housing enclosure are of a single piece once assembled. This is advantageous over traditional designs, being that there is a less likely chance for components to become missing, which can result in further loss or damage of the device, as well as serving as a huge inconvenience to a user.

In summation, the embodiments of this invention offer a substantially superior device, one that far exceeds the standards that are present in current designs in the portable data storage device market. It additionally offers substantial improved functionality and durability, and offers a novel method of attachment and detachment to external items and objects that is much more effective, and can be deployed to use much faster than conventional methods of USB flash drives, all the while being done so in a more secure manner concerning the means of deployment. It ultimately provides a housing enclosure that prevents a data storage device from being lost and misplaced, by incorporating a snap hook design element into a housing enclosure. These and other advantages will become apparent upon reviewing the ensuing description and drawings.

### SUMMARY OF THE INVENTION

The present embodiments include an enclosure housing case of a snap hook design, enabling quick attachment and detachment of a portable data storage device such as a USB flash drive from external attachment components, such as a keyring, keychain, keyfob, lanyard, necklace, belt loop, case, backpack, and other such objects and accessories. The embodiments additionally include an enclosure housing body, with bottom and top ends, which houses all of the proceeding components and serves as a containment case. This enclosure housing body contains a sliding rod assembly which includes a sliding rod and a release tab. The release tab is fixated on to the sliding rod, and protrudes outwards from the guiding slot. The guiding slot is formed along the enclosure housing body, and enables movement of the sliding rod assembly. A guiding hole is formed at the top of the body, which enables the sliding rod assembly to move through it, whereupon it reaches and makes contact with the hook.

On the opposing end of the guiding slot is a resilient object, such as a spring, which is situated between the sliding rod and an end stopper, a component that is fixated on to the enclosure housing body, so that the resilient object can be fitted and compressed into it. When the release tab is slid down, the entire sliding rod assembly is accordingly slid down, which subsequently presses itself onto the resilient object, which in turn is compressed, until it reaches the end stopper. With the sliding rod slid down, this action creates a hook opening area, whereby the area in the vicinity of the tip of the hook is now open, and items such as keyrings and lanyards may now be detached from the device. With pressure released, the sliding rod resumes to the closed position, moving through the guiding slot and guiding hole, until making contact with the hook. The fixed hook portion and the top portion of the sliding rod thus include the hook connector assembly.

At the opposing end of the body is the internal data storage device, in the embodiments a USB flash memory device, connected to an interface connector, which in the embodiments is manifested as a type-A male USB connector. A protective cover may be used to house the interface connector, which may also have a hinge incorporated on to it, as well as the enclosure housing body to avoid loss or misplacement. In addition, a coverless embodiment may be used, whereby the interface connector is retracted and extended outwards via a retracting plate which is attached to a rotating rod.

### BRIEF DESCRIPTION OF THE DRAWINGS

FIG. 1A is a frontal view of an enclosure housing case with bottom and top ends, in a closed position with a sliding rod assembly, which includes a sliding rod and a release tab, and a hook connector assembly, which includes the sliding rod and a hook.

FIG. 1B is a frontal view of the same enclosure housing case bottom and top ends in a semi-open position, with the sliding rod assembly pulled down.

FIG. 1C is a frontal view of the same enclosure housing case bottom and top ends in a fully open position, with the sliding rod assembly fully pulled down, revealing the hook opening area.

FIG. 2 is a rear view of the same enclosure housing case in a closed position.

FIG. 3 is a top view of the sliding rod and a guiding hole.

FIG. 4 is a perspective view of the sliding rod and the enclosure housing body.

FIG. 5 is a side view of the enclosure housing case in a closed position.

FIG. 6A is a perspective view of the enclosure housing case in a closed position, attached to a keyring fastened with a key.

FIG. 6B is a perspective view of the enclosure housing case in a semi-open position, loosely attached to the same keyring fastened with the same key.

FIG. 6C is a perspective view of the enclosure housing case in a fully open position, revealing the hook opening area while being detached to the same keyring fastened with the same key.

FIG. 6D is a perspective view of the enclosure housing case in a closed position, detached from the same keyring fastened with the same key.

FIG. 7 is a perspective view of the enclosure housing case inserted into a port of a laptop.

FIG. 8 is a cutaway view of the enclosure housing body, with the internal data storage device which fastens to the USB connector; as well as the sliding rod assembly, which includes the release tab and the sliding rod, with the sliding rod making contact with a resilient object, which in turn is making contact with an end stopper.

FIG. 9 is an exploded cutaway view of the sliding rod assembly, the resilient object, and the end stopper, with regards to the guiding slot.

FIG. 10 is an exploded perspective view of the enclosure housing case.

FIG. 11 is a perspective view of the enclosure housing case.

FIG. 12 is a perspective view of the enclosure housing case.

FIG. 13A is a frontal view of an alternative embodiment of the enclosure housing case in a closed position with a sliding rod assembly, which includes a sliding rod and an elongated release tab.

FIG. 13B is a frontal view of the same alternative embodiment of the enclosure housing case in a semi-open position, with the sliding rod assembly pulled down.

FIG. 13C is a frontal view of the same alternative embodiment of the enclosure housing case in a fully open position, with the sliding rod assembly fully pulled down, fully revealing the hook opening area.

FIG. 14 is an exploded view of an alternative embodiment of a sliding rod assembly which includes a sliding rod and the elongated release tab, the resilient object, and the end stopper.

FIG. 15 is an exploded perspective view of an alternative embodiment of the enclosure housing case, with a rectangular sliding rod and guiding hole.

FIG. 16 is a perspective view of the alternative embodiment of the enclosure housing case with a rectangular sliding rod and guiding hole.

FIG. 17 is a perspective view of an alternative embodiment that incorporates a sliding door which attaches through two guiding grooves, and unveils the hook opening area when pressed down in conjunction with the resilient object, in a closed position.

FIG. 18 is a perspective view of the same alternative embodiment that incorporates a sliding door in an open position, unveiling the hook opening area.

FIG. 19 is a perspective view of the sliding door and the two guiding grooves.

FIG. 20 is a perspective view of an embodiment of a protective cover of the interface connector.

FIG. 21 is a side view of the cover for the interface connector.

FIG. 22 is a side view of the cover for the interface connector and an internal cavity.

FIG. 23A is an exploded view of the housing enclosure case and a protective cover.

FIG. 23B is a perspective view of the housing enclosure case fitted to the cover.

FIG. 24A is a perspective view of an embodiment of a protective cover of the interface connector that incorporates a hinge in a closed position.

FIG. 24B is a perspective view of an embodiment of a protective cover of the interface connector that incorporates a hinge in an open position.

FIG. 25A is an exploded cutaway view of an embodiment of a retractable mechanism to protect the interface connector.

FIG. 25B is a cutaway view of an embodiment of a retractable mechanism to protect the interface connector in an extended position.

FIG. 25C is a cutaway view of an embodiment of a retractable mechanism to protect the interface connector in a retracted position.

FIG. 26 is a perspective view of a rotating rod, rotating knob, and a retracting plate.

FIG. 27 is a top view of the rotating knob.

FIG. 28 is a perspective view of the rotating rod fastened to the retracting plate.

FIG. 29 is a side view of the enclosure housing body and the interface connector.

FIG. 30A is a perspective view of the enclosure housing case in the retractable embodiment, with the interface connector in the extended position.

FIG. 30B is a perspective view of the enclosure housing case in the retractable embodiment, with the interface connector in the retracted position.

FIG. 30C is a side view of the enclosure housing case in the retractable embodiment, with the interface connector in the extended position.

FIG. 30D is a side view of the enclosure housing case in the retractable embodiment, with the interface connector in the retracted position.

FIG. 31A is a frontal view of an alternative hook embodiment of the enclosure housing case, in a closed position.

FIG. 31B is a frontal view of the same alternative hook embodiment of the enclosure housing case, in an open position, with the sliding rod assembly pulled down.

FIG. 31C is a rear view of the same alternative hook embodiment of the enclosure housing case in a closed position.

FIG. 32A is a frontal view of an alternative embodiment of the enclosure housing case that incorporates a merged hook and resilient object, in a closed position.

FIG. 32B is a frontal view of the alternative embodiment of the enclosure housing case that incorporates a merged hook and resilient object, in an open position.

FIG. 32C is a frontal view of the merged hook and resilient object in the alternative embodiment of the enclosure housing case that incorporates a merged hook and resilient object.

FIG. 32D is a cutaway view of the alternative embodiment of the enclosure housing case that incorporates a merged hook and resilient object, in a closed position.

FIG. 32E is a cutaway view of the alternative embodiment of the enclosure housing case that incorporates a merged hook and resilient object, in an open position.

REFERENCE NUMERALS

| | |
|---|---|
| 10 Enclosure housing body | 30 Keyring |
| 11 Guiding slot | 31 Key |
| 12 Hook | 32 Laptop |
| 13 Guiding hole | 33 Sliding door |
| 14 Sliding rod assembly | 34 Sliding grooves |
| 15 Sliding rod | 40 Cover |
| 16 Release tab | 41 Cavity |
| 17 Resilient object | 42 Hinge |
| 18 End stopper | 43 Rotating rod |
| 19 Interface connector | 44 Rotating knob |
| 20 Data storage device | 45 Retracting plate |
| 21 Hook opening area | 46 Holding shaft |
| 25 Hook connector assembly | 55 Top end |
| | 56 Bottom end |

### DETAILED DESCRIPTION OF THE INVENTION

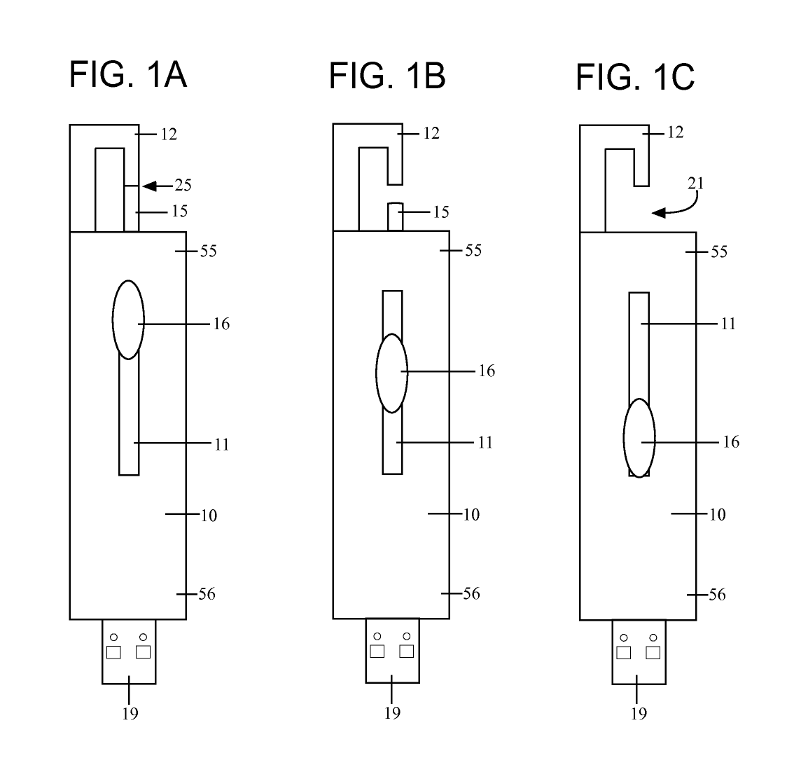

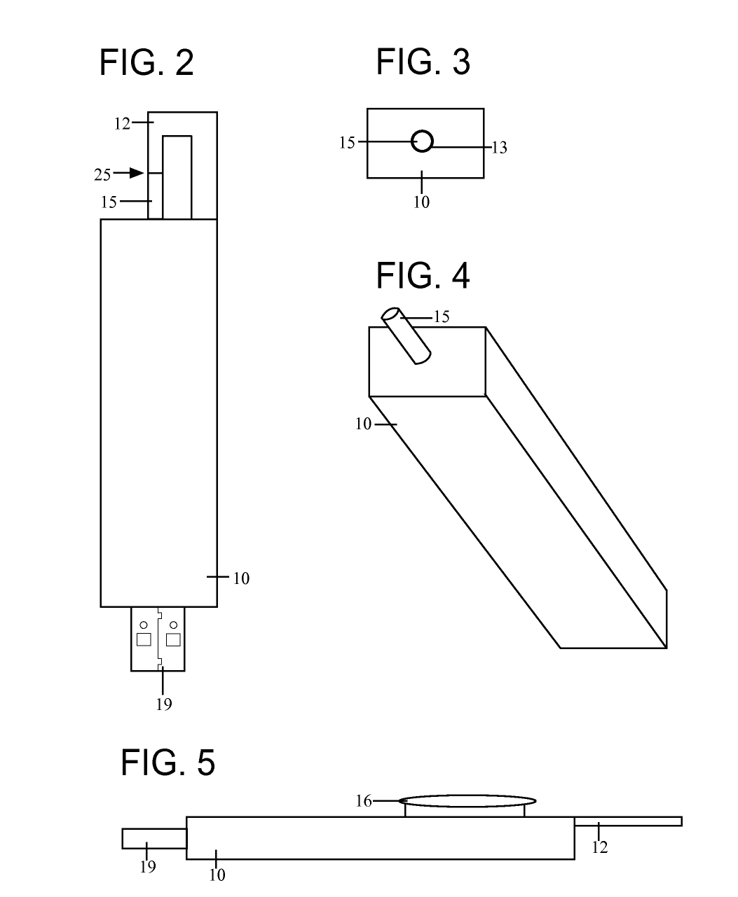

The embodiments of this invention include an enclosure housing case. As illustrated in FIGS. 1A-1C, the case includes an enclosure housing body 10 with a top end 55 and bottom end 56, a hook 12, a sliding rod assembly 14, a guiding slot 11, a resilient object or member 17, an end stopper 18, and a guiding hole 13. A hook 12 is located at the upper portion of the case, and forms to the enclosure housing body 10.

The sliding rod assembly 14 includes a sliding rod 15 and a release tab 16. As seen in the embodiments, particularly illustrated in FIGS. 3, 4, 8, 9, & 10, the sliding rod 15 is a cylindrical shaped rod, with one end being flat, and the opposing end being rounded. Release tab 16 is fixated to the sliding rod, protruding outwards. The sliding rod assembly 14 in turn slides into the guiding slot 11, and utilizes this relationship as the means to travels to the two opposing ends, they being the hook 12 and the end stopper 18. The hook connector assembly 25 in turn includes the hook 12 and the top portion of the sliding rod 15, as shown in FIG. 1A

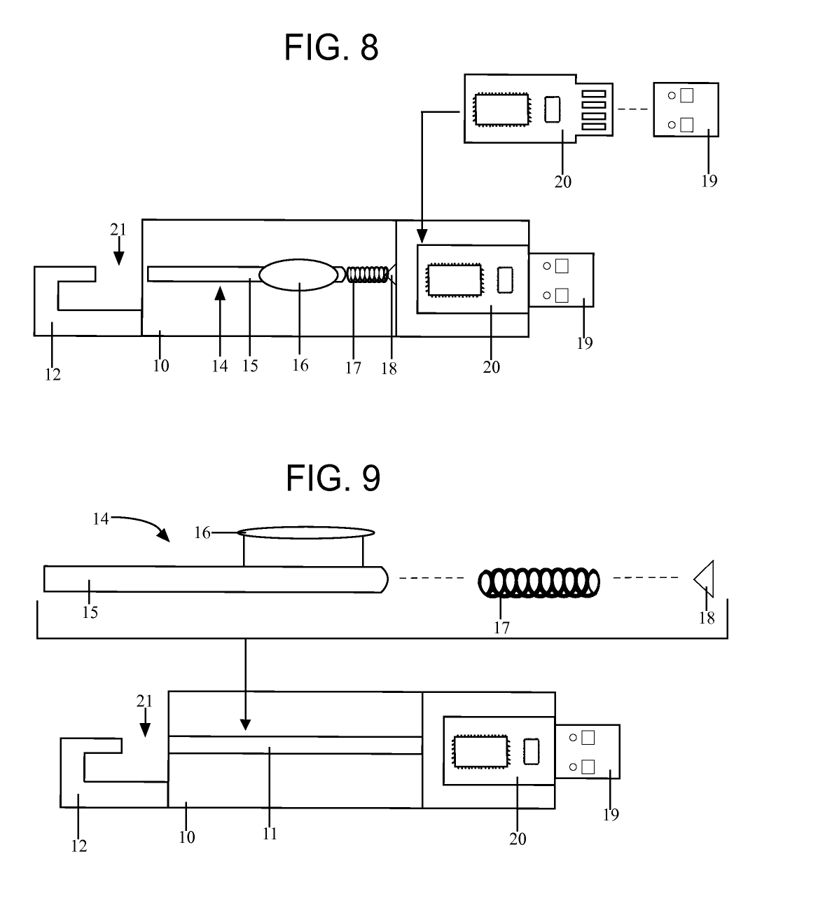

On the extreme end of the enclosure housing body is an interface connector 19 and a data storage device 20, in this embodiment, a combined USB flash drive connector, as depicted in FIGS. 8-9. This connector 19 allows for linkage between the data device and whatever electronic device it mates with, for instance a computer such as a laptop 32. Although the embodiments illustrate a type-A USB male connector, the interface connector 19 is not limited to such a specification, and other means of connectivity can be implemented. In addition, the data storage device 20 is not limited or restricted to flash memory or USB flash memory, and other mediums can be utilized as well.

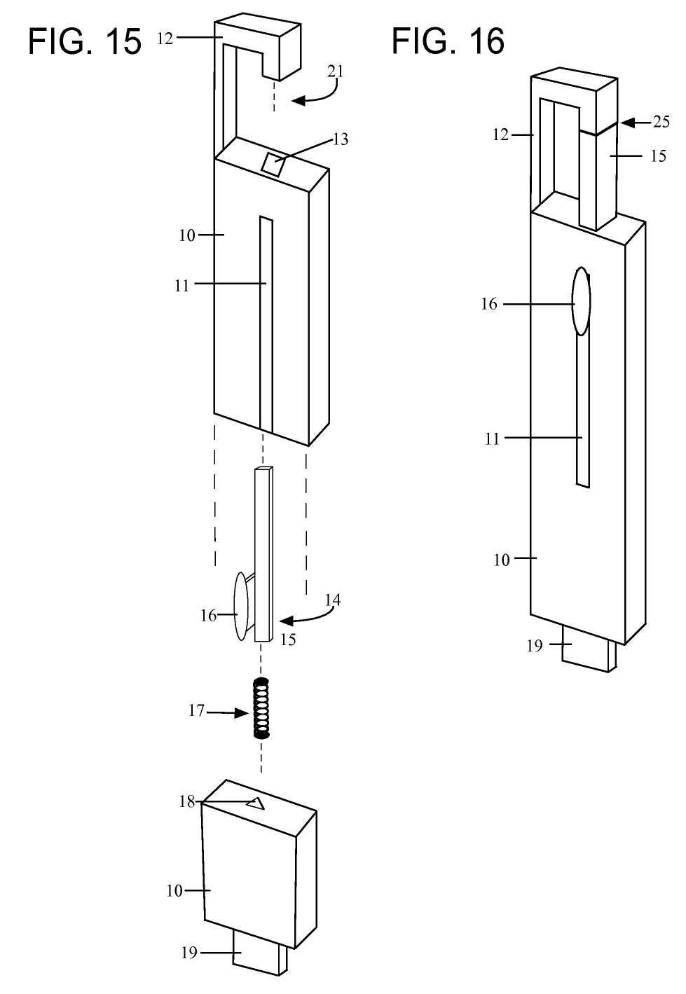

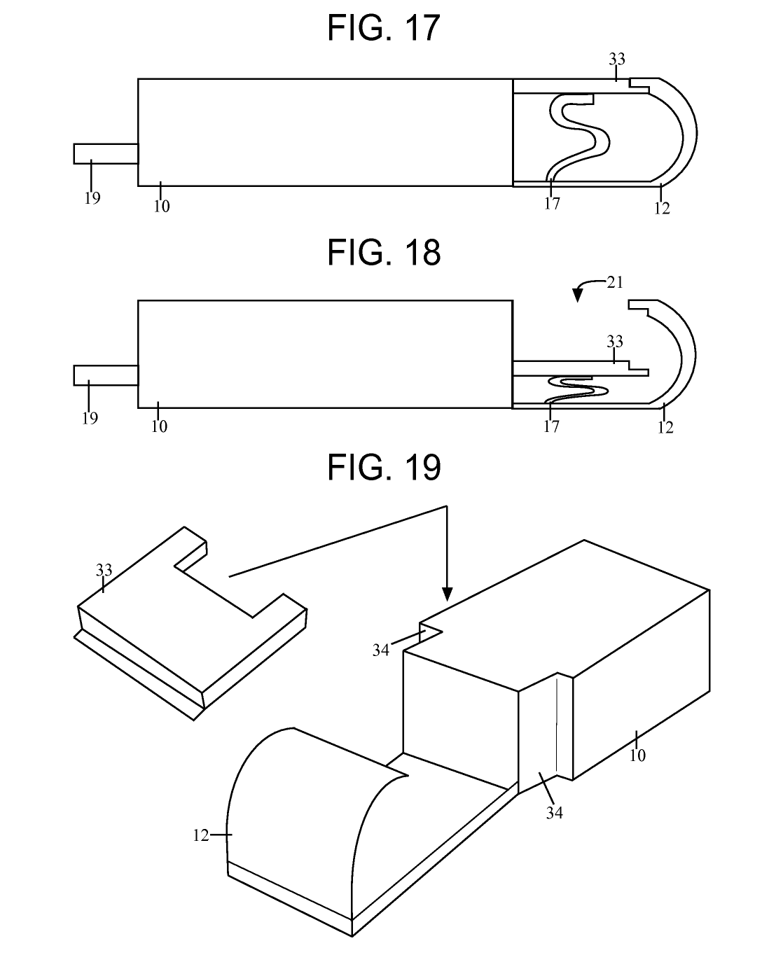

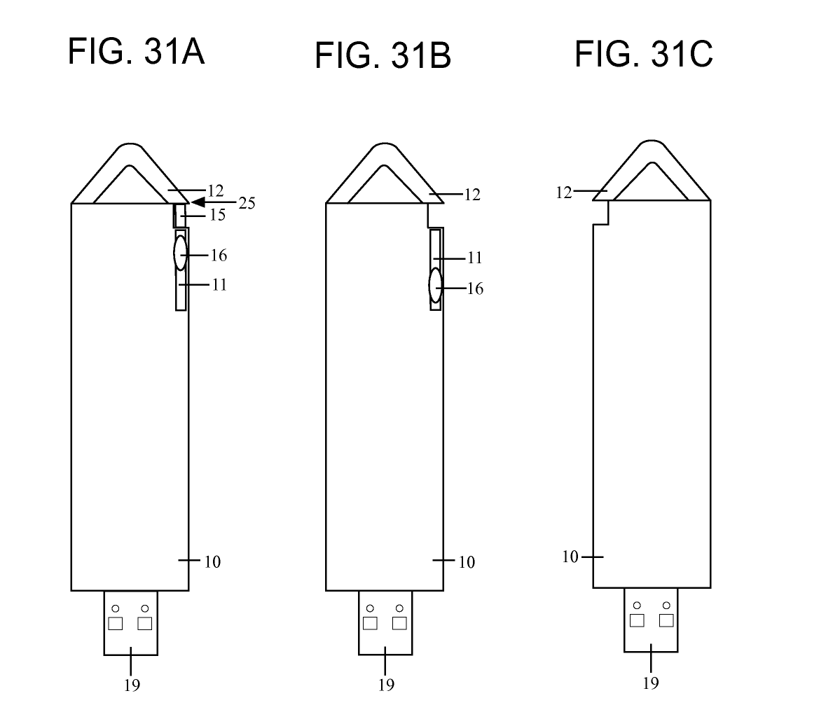

The guiding slot 11 is formed in the enclosure housing body 10. The slot is tubular, enabling the cylindrical sliding rod 15 to be fitted inside it, and to allow for movement. A guiding hole 13 is accordingly located on the top of the device, and works in conjunction with the guiding slot 11, enabling the sliding rod assembly 14 to slide through to reach the opposing end, hook 12. It is to be noted that the sliding rod 15 can be of a different geometric shape other than a cylinder and is not limited to such a form, as depicted in FIGS. 15-16. Likewise, the corresponding guiding slot 11 and guiding hole 13 are not limited to being cylindrical, and can be shaped and formed to other geometric appearances, as per the scope of function, as depicted in FIGS. 15-16. In addition, the hook 12 is not limited to a specific geometric shape, nor is the placement of the sliding rod assembly 14 and guiding slot 11, which in turn can be placed in different arrangements, for instance, as depicted in FIGS. 31A-31C.

An end stopper 18 is mounted to the enclosure housing body 10, and is situated at the end of the guiding slot 11 to hold and contain a resilient object 17, which is subsequently emplaced in the guiding slot 11 between the end stopper 18 and the sliding rod 15. The resilient object 17 serves as an intermediary contact, enabling the sliding rod assembly 14 to press against a portion of the hook 12, thereby forming the closed position. As illustrated in FIGS. 1A-1C, compression is created by pressing the release tab 16 and subsequently sliding the sliding rod assembly 14. The resilient object 17 in turn compresses due to the force and weight of the sliding rod assembly 14, subsequently enabling the sliding rod assembly 14 to move to the end of the guiding slot 11. A hook opening area 21 is formed when the sliding rod assembly 14 is fully pressed down. When the sliding rod assembly 14 is no longer pressed, the hook 12 resumes to the closed position, and the hook opening area 21 is subsequently closed.

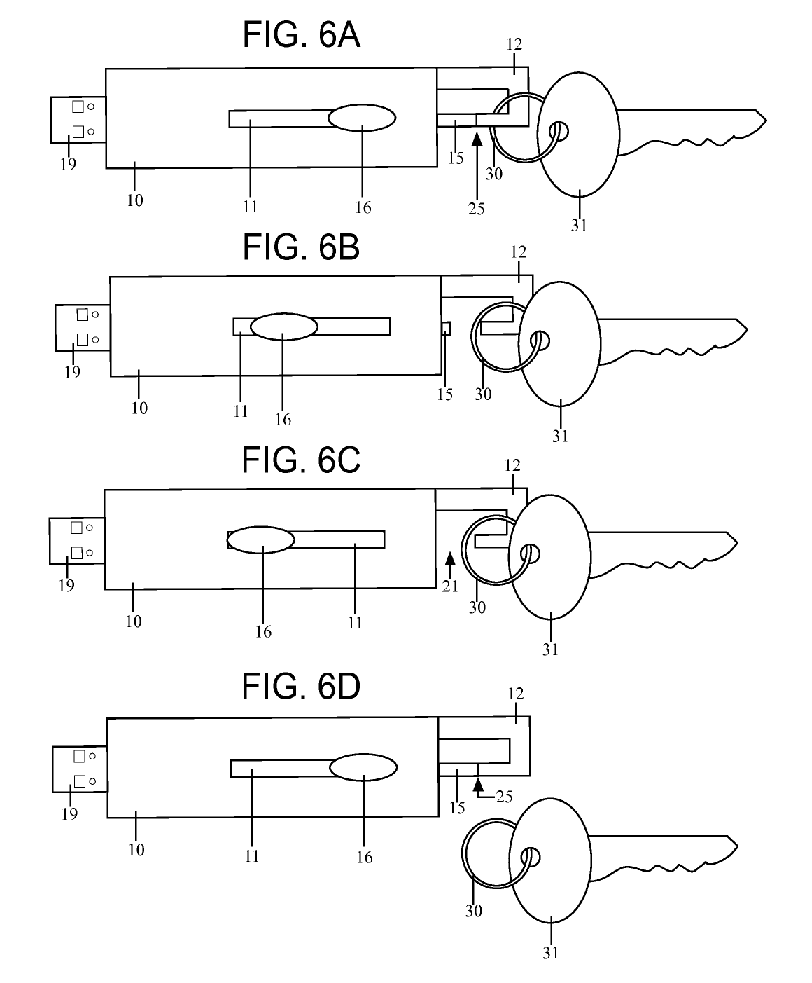

The process of pressing down the release tab 16 and subsequently unveiling the hook opening area 21 enables the device to be disconnected from an external attachment, for instance a keyring 30, as made visible in FIGS. 6A-6D. In such a scenario, a keyring 30 is attached to a key 31, a representation of a common setup, whereby a user has such a device fastened to a set of keys, all bound together via a keyring 30. In this case however, the device, when engaged by pressing the release tab 16 downwards, moves the sliding rod assembly 14 away from the hook 12, unveiling the hook opening area 21, which in turn enables the device to be disconnected from such an attachment.

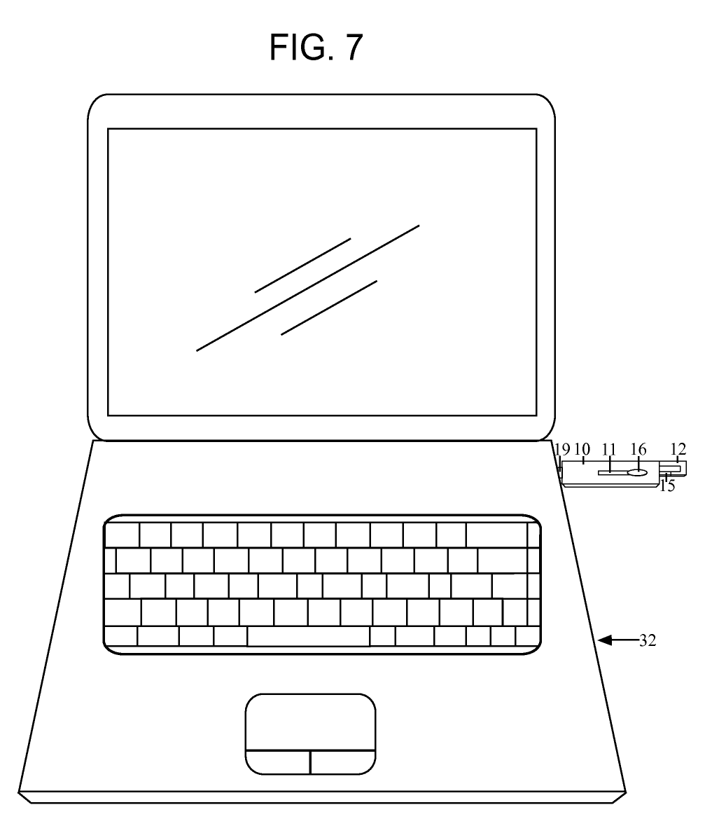

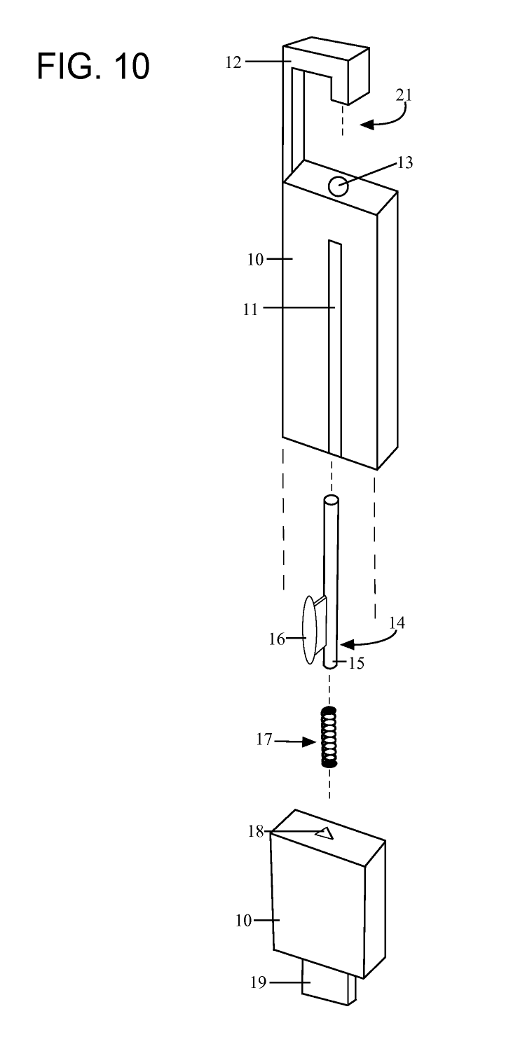

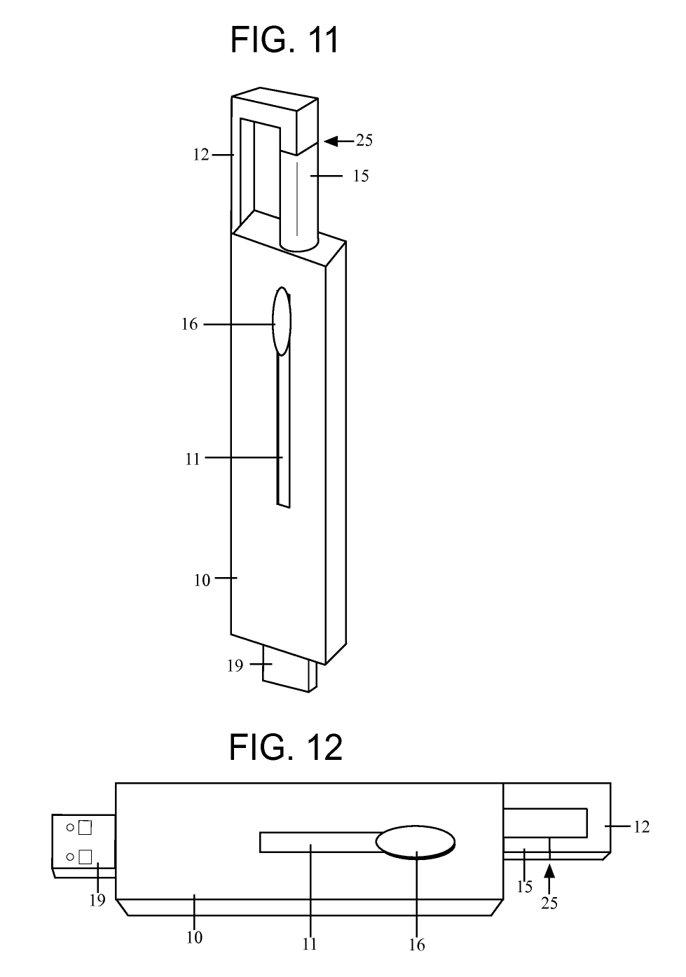

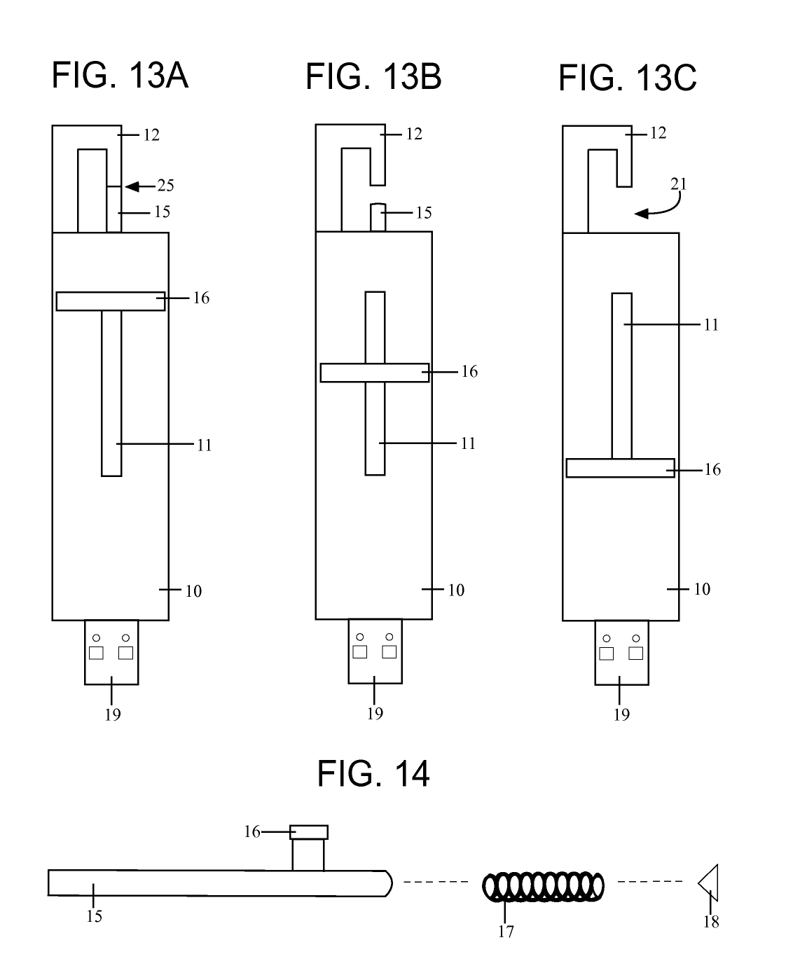

Having been detached and isolated from external attachments, the device may now be inserted to an appropriate mating device, such as a USB port of a laptop 32 for use via the interface connector 19, as illustrated in FIG. 7. Once use of the device is completed, the device is detached from such a mating device, and reattachment to the desired attachment device can now reoccur, in this case a keyring 30, by proceeding with the same procedure as depicted in FIGS. 6A-6D, only in the reverse order. As depicted in FIGS. 8-10, the order of assembly comprises of successive mounting of the end stopper 18 to the enclosure housing body 10, followed by the resilient object 17 and the sliding rod assembly 14 inserted through and inside guiding slot 11.

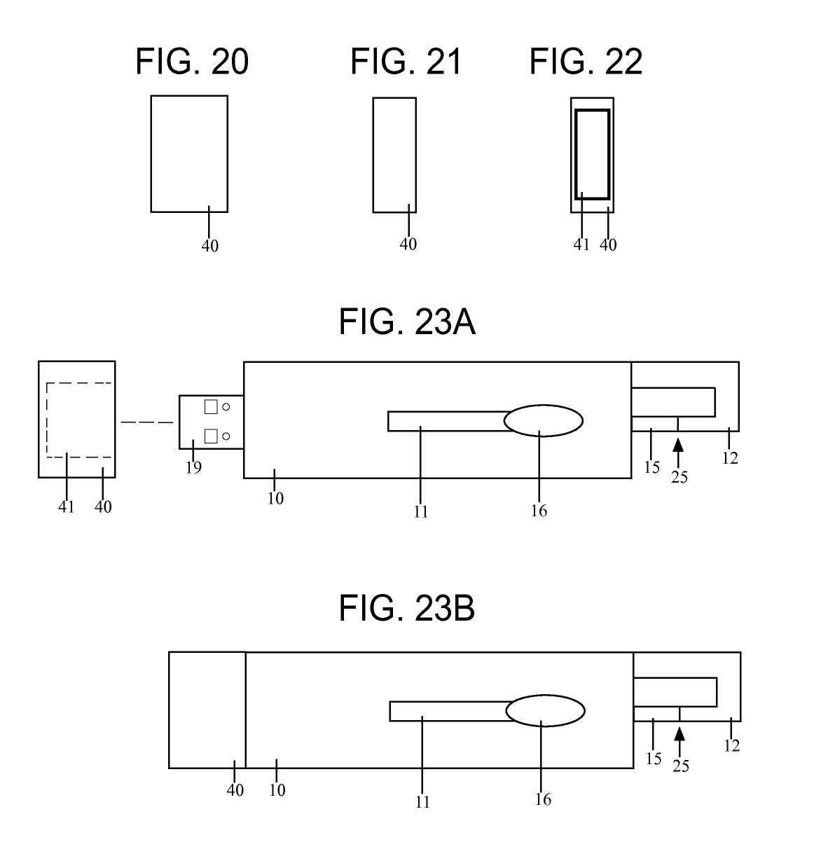

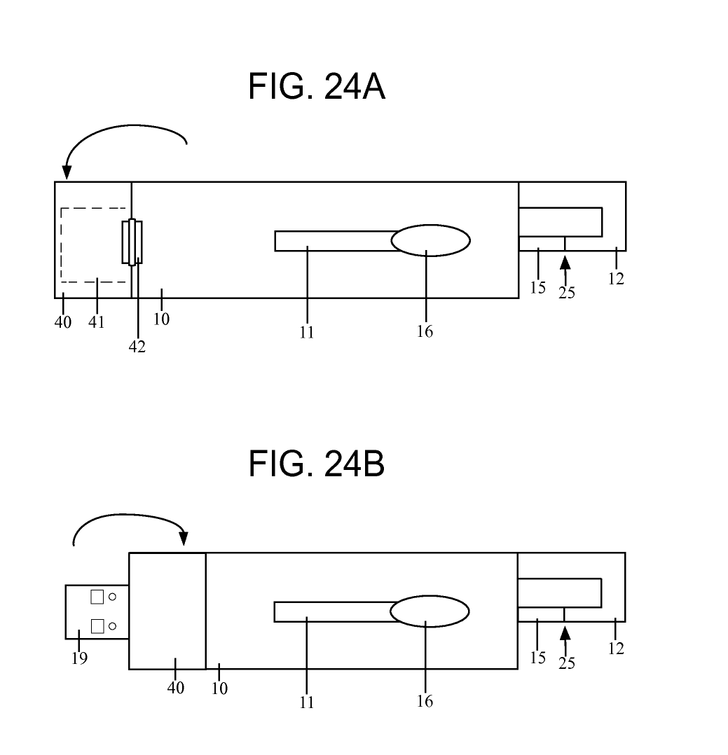

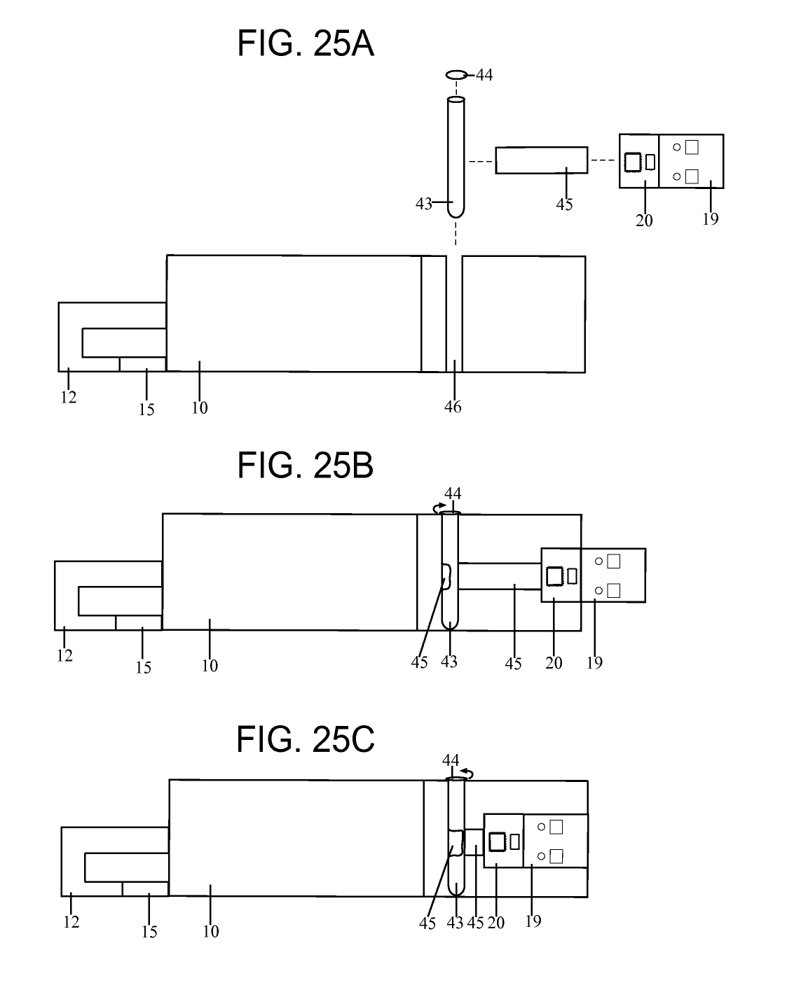

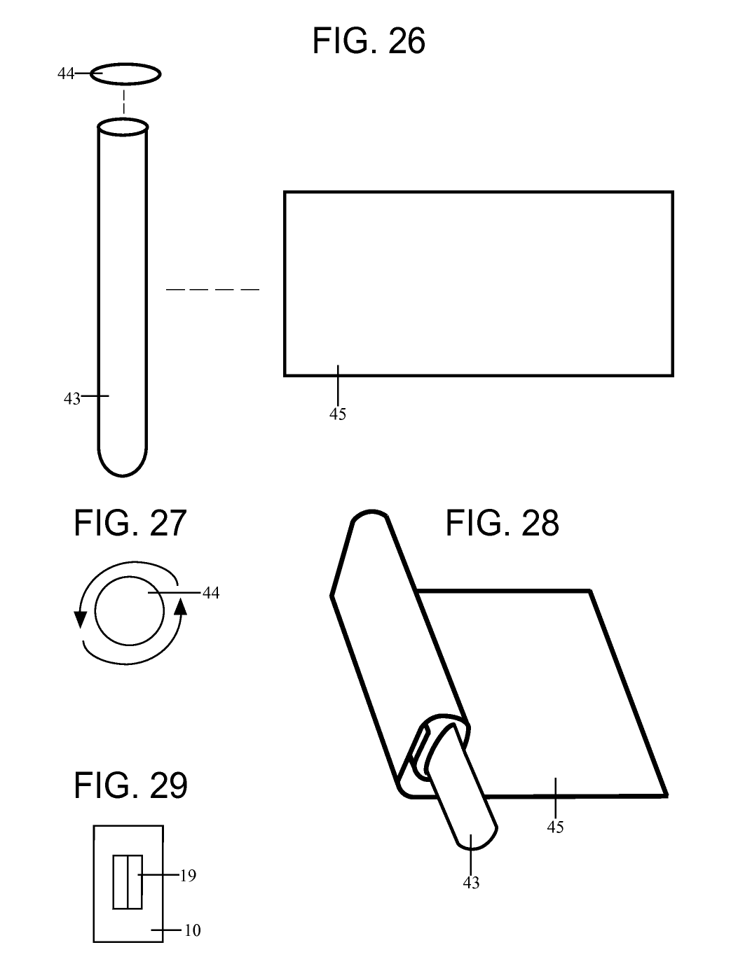

There are several embodiments concerning protection of the interface connector 19. The first embodiment, as depicted in FIGS. 20-23B, includes a cover 40 with a cavity 41 shaped to fit the interface connector 19. In this embodiment, the cover 40 attaches to the interface connector 19, meeting with the enclosure housing body 10. The second embodiment, as depicted by FIGS. 24A-24B, has a hinge 42 mounted to the enclosure housing body 10 and the cover 40. The cover 40 pops open and swings back to an open position, revealing the interface connector 19. In a third embodiment, a retracting method without a cover is implemented, which includes a rotating rod 43, rotating knob 44, retracting plate 45, and holding shaft 46, as depicted in FIGS. 25A-28. The rotating rod 43 slides into the holding shaft 46, and attaches to a retracting plate 45, which in turn is attached to the data storage device 20.

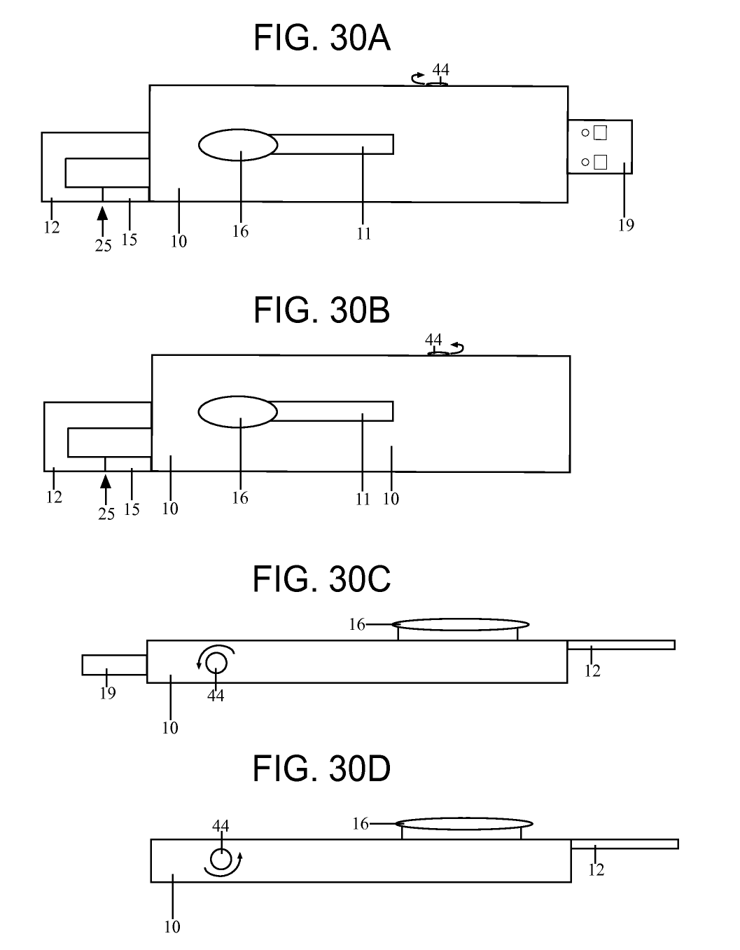

A rotating knob 44 is fastened on top of a rotating rod 43 to enable precise movement of the rotating rod 43 from the exterior. When the rotating knob 44 is turned clockwise, the rotating rod 43 subsequently is turned, which in turn reels in the retracting plate 45, pulling out the data storage device 20, which in turn extends out the interface connector 19 out of the enclosure housing body 10, as illustrated in FIG. 30A. When the rotating knob 44 is turned counterclockwise, the rotating rod 43 turns in concert, reeling in the retracting plate 45, which in turn retracts both the data storage device 20 and the interface connector 19, as illustrated in FIG. 30B.

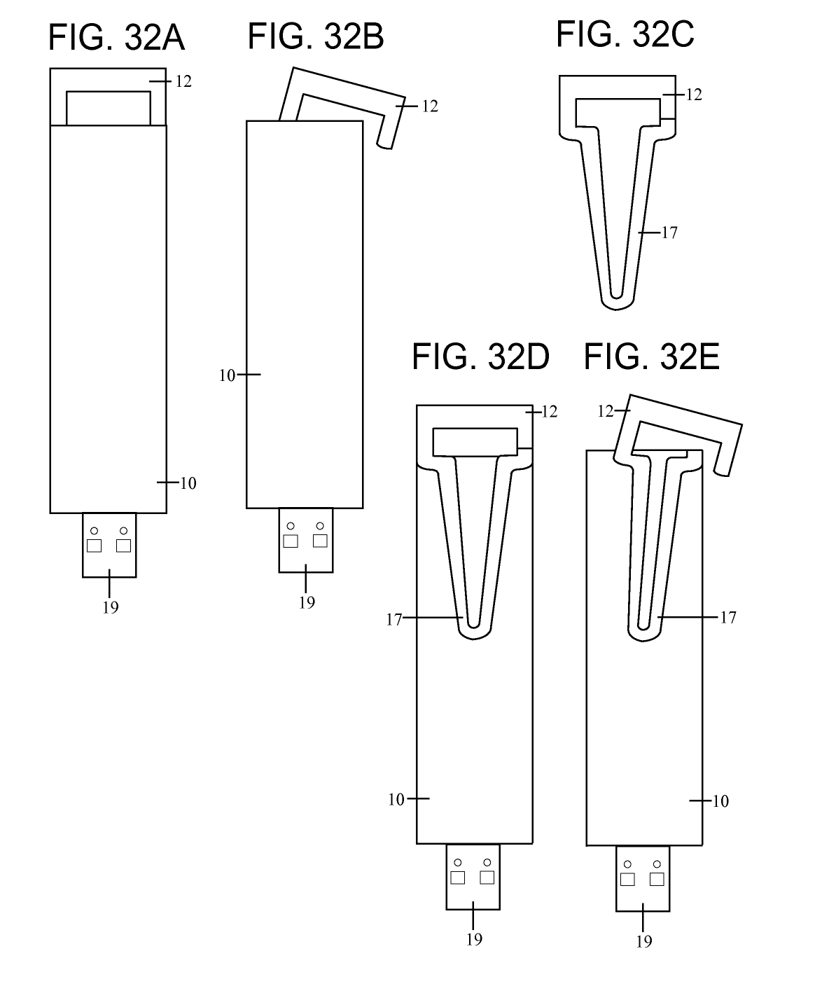

A merged hook and resilient object embodiment is depicted in FIGS. 32A-32E. In this embodiment, the hook 12 is still present, while having the resilient object 17 as an attached bottom extension, as shown in FIG. 32C. The merged hook 12 and resilient object 17 are inserted in the enclosure housing body 10, and are preferably made of a metal, although a plastic material may be used as well. However, the device is not limited to such materials and other similar compressible materials may be used. In this embodiment, pressure is attached to the hook 12, which in turn compresses the resilient object 17, allowing the hook to shift, and allowing the hook opening area 21 to be formed, as shown in FIGS. 32D-32E.

Although the afore mentioned descriptions contain many specificities, these specificities should not be viewed as limiting the scope of the embodiments, but rather, as merely providing illustrations of several embodiments. It is to be understood that the described invention is not to be limited or restricted by the specific embodiments mentioned herein, and that changes, alterations, and modifications may be made, within the scope and essence of the described concepts. The scope of the embodiments should therefore be determined by the following claims:

What is claimed is:

1. An enclosure housing case for a portable data storage device comprising:
an enclosure housing body having opposing first and second ends;
a hook connector assembly including a hook portion and a sliding rod assembly, said hook portion mounted to and extending from the first end of the enclosure housing body, and said sliding rod assembly including a sliding rod slidably disposed in said enclosure housing body, a release tab connected to said sliding rod and extending through a guiding slot in said enclosure housing body, said hook connector assembly having an open configuration and a closed configuration, said sliding rod being movable between a first position in which said hook connector assembly is in said closed configuration and a second position in which said hook connector assembly is in said open configuration, and said sliding rod being biased toward said first position; and
a data storage device disposed in said enclosure housing body, said data storage device including an interface connector electrically connected to said data storage device, and said interface connector being configured to extend from the second end of the enclosure housing body.

2. The enclosure housing case of claim 1, wherein said hook connector assembly comprises a snap hook.

3. The enclosure housing case of claim 1, wherein said enclosure housing body first end defines a guiding hole, and said sliding rod is configured to be slidably received and guided through said guiding hole.

4. The enclosure housing case of claim 1, wherein said sliding rod assembly includes an end stopper fixedly mounted in said enclosure housing body, and said sliding rod is biased toward said first position by a resilient member situated between the sliding rod and the end stopper.

5. The enclosure housing case of claim 4, wherein said resilient member comprises a spring.

6. The enclosure housing case of claim 1, wherein said data storage device and said interface connector are configured to connect to an electronic peripheral for the exchange of data between said peripheral and said data storage device.

7. The enclosure housing case of claim 1, wherein said interface connector is a USB connector.

8. The enclosure housing case of claim 1, wherein said data storage device comprises a USB flash memory device.

9. The enclosure housing case of claim 1, wherein said interface connector is mounted to a moveable retracting plate connected to a rotatable knob extending from said enclosure housing body such that said interface connector is moveable at said second end of said enclosure housing body between a position retracted within said enclosure housing body and a position extended from said second end of said enclosure housing body.

10. The enclosure housing case of claim 1, wherein said enclosure housing body comprises a cover configured to receive and removably cover said interface connector, said cover being pivotally mounted to said first end of said enclosure housing body by a hinge and movable between a position covering said interface connector and a position uncovering said interface connector.

11. An enclosure housing case for a portable data storage device comprising:
an enclosure housing body having opposing first and second ends, said enclosure housing body first end defining a guiding hole;
a hook connector assembly including a hook portion and a sliding rod assembly, said hook portion mounted to and extending from the first end of the enclosure housing body, and said sliding rod assembly including a sliding rod slidably disposed in said enclosure housing body, a release tab connected to said sliding rod and extending through a guiding slot in said enclosure housing body, said sliding rod being slidably received in and guided through said guiding hole, said hook connector assembly having an open configuration and a closed configuration, said sliding rod being movable between a first position in which said hook connector assembly is in said closed configuration and a second position in which said hook connector assembly is in said open configuration, and said sliding rod being biased toward said first position; and
a data storage device disposed in said enclosure housing body, said data storage device including an interface connector electrically connected to said data storage device, and said interface connector being configured to extend from the second end of the enclosure housing body.

12. The enclosure housing case of claim 11, wherein said hook connector assembly comprises a snap hook.

13. The enclosure housing case of claim 11, wherein said sliding rod assembly includes an end stopper fixedly mounted in said enclosure housing body, and said sliding rod is biased toward said first position by a resilient member situated between the sliding rod and the end stopper.

14. The enclosure housing case of claim 13, wherein said resilient member comprises a spring.

15. The enclosure housing case of claim 11, wherein said data storage device and said interface connector are configured to connect to an electronic peripheral for the exchange of data between said peripheral and said data storage device.

16. The enclosure housing case of claim 11, wherein said interface connector is a USB connector.

17. The enclosure housing case of claim 11, wherein said data storage device comprises a USB flash memory device.

18. The enclosure housing case of claim 11, wherein said interface connector is mounted to a moveable retracting plate connected to a rotatable knob extending from said enclosure housing body such that said interface connector is moveable at said second end of said enclosure housing body between a position retracted within said enclosure housing body and a position extended from said second end of said enclosure housing body.

19. The enclosure housing case of claim 11, wherein said enclosure housing body comprises a cover configured to receive and removably cover said interface connector, said cover being pivotally mounted to said first end of said enclosure housing body by a hinge and movable between a position covering said interface connector and a position uncovering said interface connector.
